(19) United States
(12) Patent Application Publication
(10) Pub. No.: US 2010/0332277 A1
(43) Pub. Date: Dec. 30, 2010

(54) METHOD, ARTICLE AND SYSTEM FOR CONSOLIDATED CHANGE MANAGEMENT

(75) Inventors: Ralf DENTZER, Hockenheim (DE); Matthias RICHTER, Sinsheim (DE); Philipp SUENDERHAUF, Leimen (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 12/492,532

(22) Filed: Jun. 26, 2009

(51) Int. Cl. G06Q 10/00; G06F 17/30

(52) U.S. Cl. 705/8; 707/912; 707/955; 707/812

(57) ABSTRACT

A change manager may receive a new event notification. Once a new event notification has been received by the change manager, change information may be received by the change manager. The change information may be associated with one or more data objects that have been changed during the processing of a new event. As each change is received by the change manager, the changes may be stored within a consolidated change buffer. After a new event has been completed, a consolidated change notification may be sent by the change manager to one or more consumers.

### BACKGROUND

Current enterprise systems may process events that require changes to one or more data objects. A single event may require changes to multiple data objects. An example of an event may be a new hire event in a human resources application. When a new hire event is initiated, several separate sub-events may need to take place. For example, multiple data objects may need to be modified or created, such as an employee data object and an employment agreement data object. Notifications of changes to data objects may need to be sent to various applications within the enterprise system. For example, an application that initiated the event may require notification. In addition, other applications within the enterprise system may desire to receive updates when certain data objects have been created or modified. For example, even though a human resource application initiated a new hire event, a compensation management application may also be interested in receiving updates to all employee data objects and all employment agreement data objects.

Conventionally, as each data object is created or modified, all interested applications within an enterprise system may be notified of the change. However, this may result in numerous notifications that could create confusion for applications unaware of the cause for the change. Therefore, an improved solution for the management of changes to data objects and notification of those changes is needed.

### BRIEF DESCRIPTION OF THE DRAWINGS

FIG. 1 is a diagram illustrating a change management system according to an embodiment.

FIG. 2 illustrates an embodiment of a method for change management.

FIG. 3 is a flow diagram illustrating a change management system according to an embodiment.

FIG. 4 is a flow diagram illustrating a change management system according to an embodiment.

FIG. 5 illustrates an embodiment of a system for change management.

### DETAILED DESCRIPTION

Various embodiments disclose a method for managing changes made to data objects in an enterprise system. The current solutions provides a change manager to provide consolidate change notifications to interested consumers. A consumer may be an application, system component or system user. In this manner, consumers receive a single consolidated notification when an event has been completed. Further, since the change notification contains information regarding changes to all data objects associated with an event, all notified consumers will understand the reason for the change notification. Once a consolidated change notification has been received by a consumer, the consumer may use the consolidated change information to perform system tasks.

An embodiment of the present invention includes a computer-implemented method of consolidated change management. A change manager may receive a new event notification. Once a new event notification has been received by the change manager, change information may be received by the change manager. The change information may be associated with one or more data objects that have been changed during the processing of a new event. As each change is received by the change manager, the changes may be stored within a consolidated change buffer. After a new event has been completed, a consolidated change notification may be sent by the change manager to one or more subscribers.

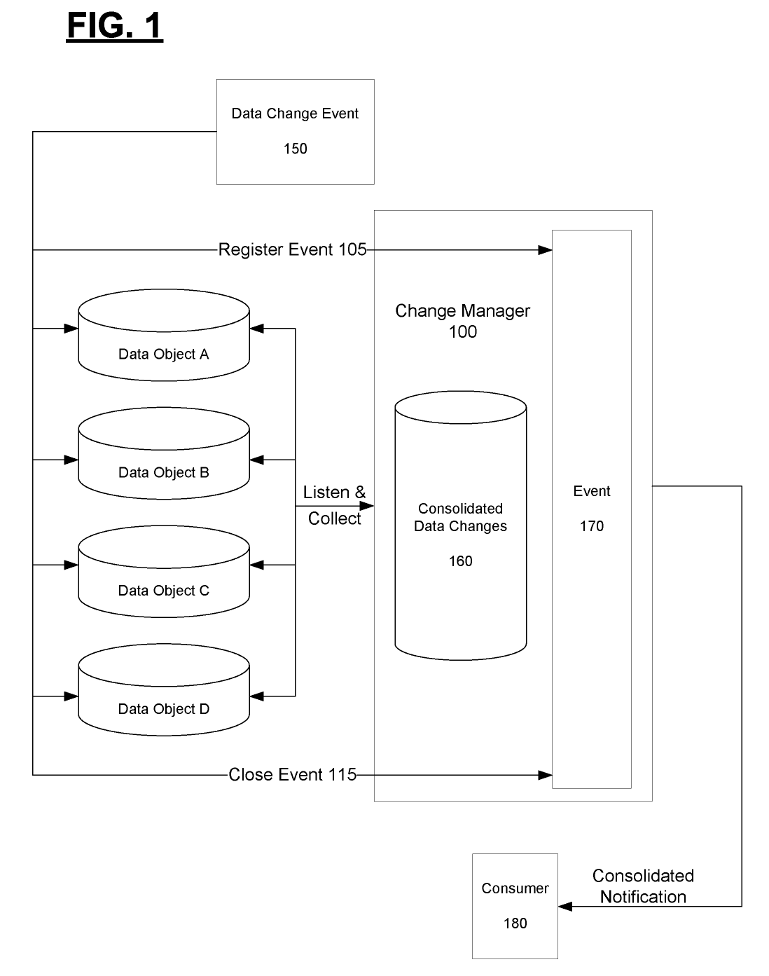

FIG. 1 is a diagram illustrating a change management system according to an embodiment. Change manager 100 may be used to register events and subsequently store information related to changes made to data objects associated with a registered event. Data change event 150 may be an event initiated by the consumer of an enterprise system or by the system itself. Data change event 150 may be registered with event 170 at step 105. This occurs prior to any changes to data objects associated with data change event 150. Data change event 150 and information associated with data change event 150 may be stored by change manager 100 at event 170. For example, event 170 may store information about data objects associated with an event, or sub-events that may be required by an event.

After an event has been registered with change manager 100, change manager 100 may listen for changes to data objects associated with the event. The actual changes to data objects may be made by a process executing the event. Changes to data objects may be stored in one or more data objects or business objects. As changes are made to each data object, change manager collects data associated with each change in consolidated data changes 160. Consolidated data changes 160 may be a memory storing a database.

In the example illustrated, data change event 105 has four associated data objects, A, B, C and D. As each data object is modified, change manager 100 may collect information associated with the modification and may store the information in consolidated data changes 160. After all required changes have been made to data objects A, B, C and D, a close event 115 may be communicated to change manager 100. Close event 115 may indicate that that all changes to data objects have been made and that the event has been completed. Upon receiving close event 115, change manager 100 may send a notification to one or more consumers associated with the event. Associated consumers may have subscribed to the event or subscribed to notifications associated with one or more data objects modified during the event. Change manager 100 may access a registration database that may include relationships between consumers and events. If a consumer has registered for change notification within an event, the registration may be listed within the registration database.

Consumers may receive a consolidated change notification that indicates one or more changes to data objects. The consumers may be application programs that may be interested in using change information to compile new data sets or perform other functions necessary within the enterprise system. For example, a compensation management application may be interested in changes to human resources data objects. After the completion of a new hire event, a compensation management application may use the information provided by the change manager to access changed data objects and calculate updates to employee compensation data. Further, the compensation management application may use the information to notify one or more users of the enterprise system, such as accountants, of new compensation data. The embodiments are not limited to this example.

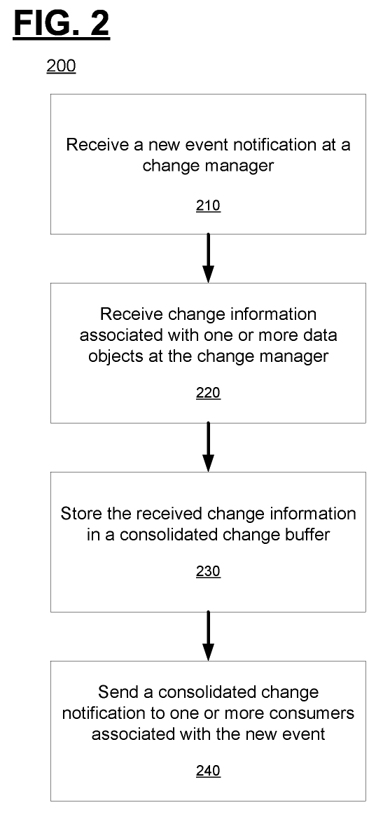

FIG. 2 illustrates one embodiment of a method for change management. Flow chart 200 illustrates exemplary steps taken in a method for consolidated change management. At step 210, a change manager may receive a notification that a new event will be processed. At step 220, the change manager may receive change information relating to one or more data objects. A single event may require modifications to one or more data objects. Further, an event may include one or more sub-events. As changes to data objects are made, the change manager may receive change information regarding those changes. The change manager may listen to changes being made to data objects as well. For example, a new event notification may include information regarding data objects that will be modified. Using this information, the change manager may monitor identified data objects for change information.

At step 230, the change manager may store change information in a consolidated change buffer. The consolidated change buffer may be a computer-readable medium used to store change information associated with modified data objects. A record may be created for each data object that has been modified during an event. Each record may also include a detailed summary of the changes that were made to the data object.

At step 240, a consolidated change notification may be sent to one or more consumers associated with the new event. The consolidate change notification may include information about each object that was changed, detailed information about the changes made to each object and information about the event that caused the data objects to be changed. The change manager may look up associated consumers in a relational database that associates consumers with particular data objects or events.

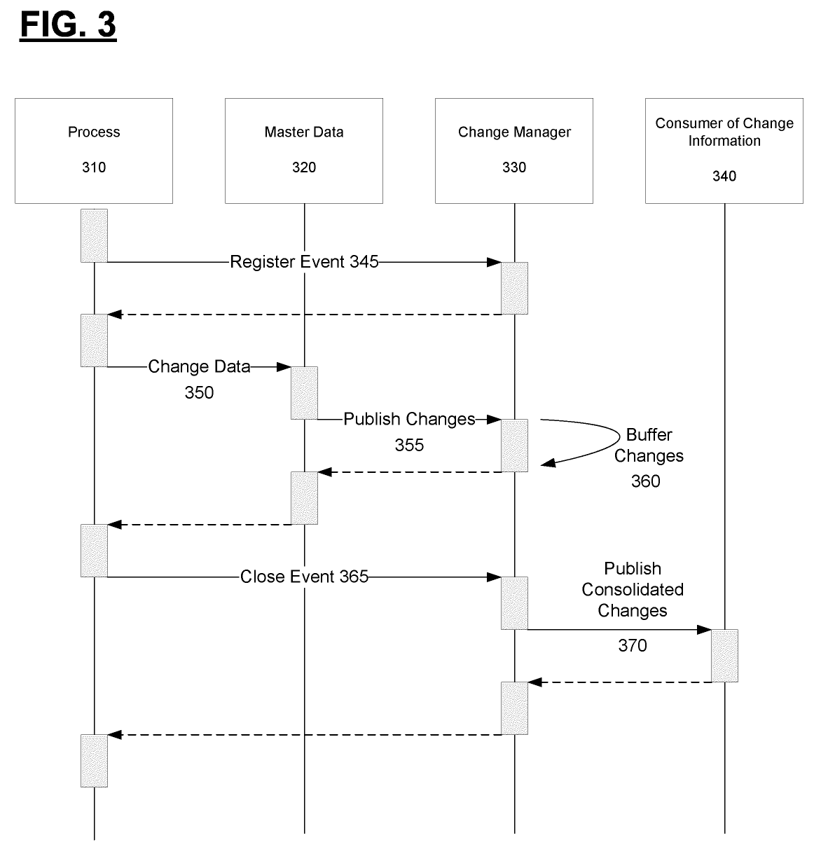

FIG. 3 is a flow diagram illustrating a change management system according to one embodiment. Process 310 may be responsible for sending register event notification 345 to change manager 330. Register event notification 345 may include subscriber information identifying one or more consumers associated with a new event. Register event notification 345 may also include information identifying data objects scheduled to be changed by the new event.

Once the process 310 has registered a new event at change manager 330, the process 310 may make changes to data objects at step 350. Data objects that are changed may be stored in master data 320. The data objects stored in master data 320 may be universally available to the consumers of an enterprise management system. As changes are being made to each data object, the data object may be locked and may not be accessed or changed while the change is taking place. After each change has been made, change information may be published to change manager 330. Change manager 330 may buffer each published change into a consolidated change buffer at step 360.

An event may include one or more changes to data objects stored in master data 320. At the conclusion of the event, a close event notification may be sent from process 310 to change manager 330 at step 365. At step 370, change manager 330 may respond to a close event notification by publishing a consolidated summary of changes made during the event to a consumer of change information 340. Consumer of change information may be one or more consumers that have subscribed to one or more data objects or events or are otherwise associated with one or more data objects or events.

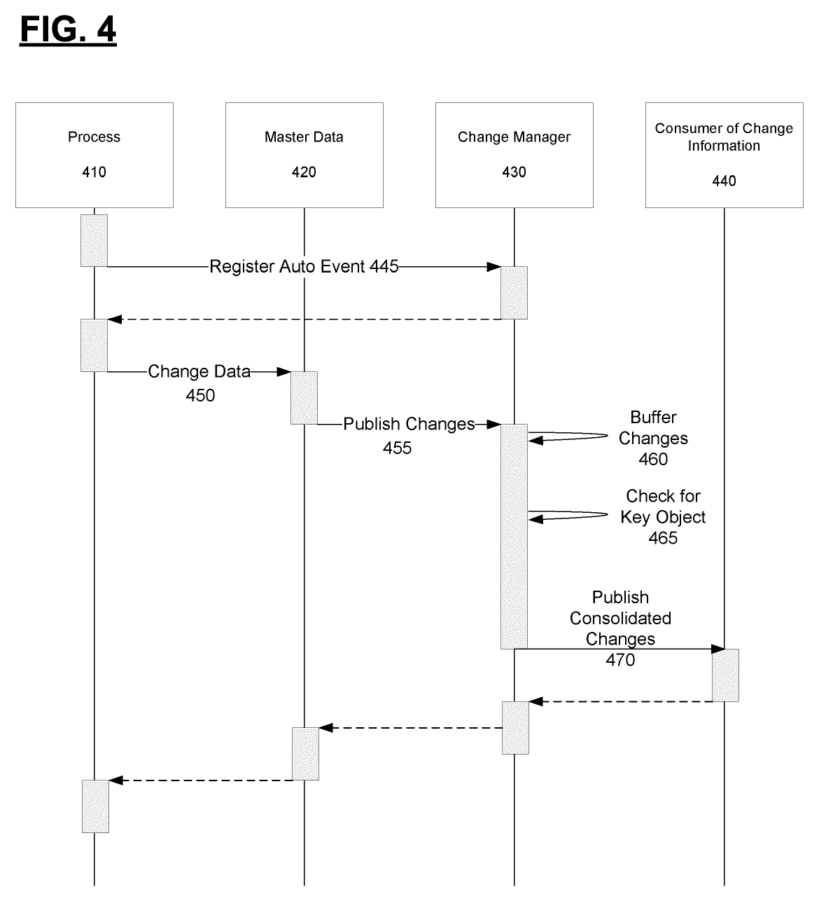

FIG. 4 is a flow diagram illustrating a change management system according to one embodiment. In some situations, it may not be desirable for process 410 to send a close event notification to change manager 430. In these situations, an auto event may be used. At step 445, an auto event may be registered with change manager 430. The auto event may identify a key data object that is associated with an automatic close event notification. The key data object may be the last object to be changed by process 410 during the auto event. At step 450, process 410 may make changes to data objects in accordance with the auto event. As each change is made, changes may be published to change manager 430 at step 455. As changes are published, change manager 430 may store the changes and information related thereto in a consolidated change buffer.

At step 465, change manager 430 may check each published change. As each change is published, change manager 430 may check whether the key data object has been changed. A change to the key data object may trigger a consolidated change notification. When the key data object has been modified, the change manager 430 may detect the change and publishes a consolidated change notification at step 470. In this manner, it is unnecessary for process 410 to send a close event notification to the change manager to trigger a consolidated change notification.

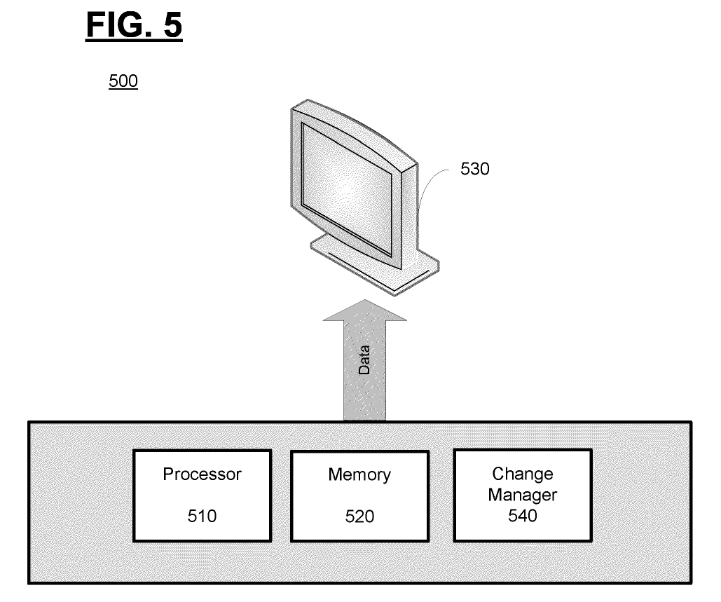

FIG. 5 illustrates one embodiment of a system for change management. System 500 includes processor 510. Processor 510 may be used to execute one or more instructions or logic as illustrated in the above described figures. Memory 520 may be a computer-readable storage medium that stores instructions that are executed by processor 510. Further, memory 520 may include a master data store for one or more data objects. The results of an event or a consolidated change notification may be displayed on display 530.

System 500 includes change manager 540. Change manager 540 may be implemented in software and may be stored on memory 520. Change manager may be responsible for collecting change information and notifying one or more consumers of consolidated change information in accordance with one or more embodiments described herein.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be implemented, for example, using a computer-readable medium or article which may store an instruction or a set of instructions that, if executed by a machine, may cause the machine to perform a method and/or operations in accordance with the embodiments. The machine may be a computer or series of interconnected computers. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

We claim:

1. A computer-implemented method to manage change notifications, the method comprising:
receiving a new event notification at a change manager;
receiving change information associated with one or more data objects at the change manager;
storing the received change information in a consolidated change buffer; and
sending a consolidated change notification to one or more consumers associated with the new event.

2. The method of claim 1, wherein subscriber information identifying the one or more consumers associated with the new event is stored in a registration database accessible by the change manager.

3. The method of claim 1, further comprising:
receiving a close event notification at the change manager indicating that a consolidated change notification should be sent to the one or more consumers associated with the new event.

4. The method of claim 1, wherein the new event notification identifies a key data object associated with an automatic close event notification.

5. The method of claim 4, wherein the consolidated change notification is sent to one or more consumers associated with the new event in response to a change to the key data objected associated with an automatic close event notification.

6. The method of claim 1, wherein the consolidated change notification includes a summary of changes made to the one or more data objects.

7. The method of claim 6, wherein the consolidated change notification identifies an event that is associated with the received change information.

8. An article comprising a computer-readable storage medium including instructions that, when executed by a processor, perform the steps of:
receiving a new event notification at a change manager;
receiving change information associated with one or more data objects at the change manager;
storing the received change information in a consolidated change buffer; and
sending a consolidated change notification to one or more consumers associated with the new event.

9. The article of claim 8, wherein subscriber information identifying the one or more consumers associated with the new event is stored in a registration database accessible by the change manager.

10. The article of claim 8, further comprising:
receiving a close event notification at the change manager indicating that a consolidated change notification should be sent to the one or more consumers associated with the new event.

11. The article of claim 8, wherein the new event notification identifies a key data object associated with an automatic close event notification.

12. The article of claim 11, wherein the consolidated change notification is sent to one or more consumers associated with the new event in response to a change to the key data objected associated with an automatic close event notification.

13. The article of claim 8, wherein the consolidated change notification includes a summary of changes made to the one or more data objects.

14. The article of claim 13, wherein the consolidated change notification identifies an event that is associated with the received change information.

15. A system comprising:
a processor;
a change manager to receive a new event notification from the processor, the change manager to receive change information about made to one or more data objects during the execution of the new event by the processor and to send a consolidated change notification to one or more consumers associated with the new event; and
a consolidated change buffer to store the received change information.

16. The system of claim 15, wherein subscriber information identifying the one or more consumers associated with the new event is stored in a registration database accessible by the change manager.

17. The system of claim 15, wherein the change manager to receive a close event notification from the processor indicating that a consolidated change notification should be sent to the one or more consumers associated with the new event.

18. The system of claim 15, wherein the new event notification identifies a key data object associated with an automatic close event notification.

19. The system of claim 18, wherein the consolidated change notification is sent by the change manager to one or more consumers associated with the new event in response to a change to the key data objected associated with an automatic close event notification.

20. The system of claim 15, wherein the consolidated change notification includes a summary of changes made to the one or more data objects.
